(19) United States
(12) Patent Application Publication
(10) Pub. No.: US 2026/0292530 A1
(43) Pub. Date: Sep. 24, 2026

(54) DYNAMIC BEAMFORMING CONFIGURATION

(71) Applicant: T-Mobile USA, Inc., Bellevue, WA (US)

(72) Inventor: Jasinder Pal Singh, Olathe, KS (US)

(21) Appl. No.: 19/087,661

(22) Filed: Mar. 24, 2025

(51) Int. Cl. H04W 16/28; H04L 5/00

(52) U.S. Cl. CPC H04W 16/28; H04L 5/0048

(57) ABSTRACT

System and methods for determining beamforming configurations for UEs based on a variety of factors are described. A base station may determine data throughput requirements of one or more slices associated with a UE and available SRS-based beamforming resources to determine a threshold distance from the base station at which the UE is to adjust its beamforming configuration. When the base station determines that the UE has reached the threshold distance, the base station will generate and transmit instructions to the UE to update its beamforming configuration.

### BACKGROUND

Wireless communications technologies have improved significantly over recent years, resulting in the proliferation of wireless communications devices (e.g., user devices such as mobile telephones, smartphones, tablets, laptops, etc.). Among such improvements is the use of multiple antennas configured at an individual wireless communications device. Various techniques have also been developed to more effectively and efficiently use such multiple antennas (often referred to as an antenna array) for the transmission and reception of wireless signals, including beamforming and multiple-input and multiple-output (MIMO). Beamforming is a signal processing technique that may, among other features, introduce directivity to an antenna array. MIMO techniques facilitate the use of multiple antennas (and/or multiple transmissions and/or receptions) at a single wireless communications device and/or over a single radio channel. These and other techniques used with multiple antennas and/or multiple transmissions at a single wireless communications device have greatly increased the bandwidth available at such devices.

Along with increases in the number and capability of devices, the variety of services available to such devices has also increased. For example, voice and Internet connectivity are both available on nearly all wireless communications devices available today. Thus, the networks servicing such devices are typically configured to provide multiple services to wireless communications devices. However, different services may have different requirements and configurations. For example, latency and delay may be more impactful to real-time communications services (e.g., voice and video calls) than to web browser applications.

Because the requirements and configurations used to implement various types of services on a wireless communications network may differ between service types, it may be challenging to quickly and efficiently establish and operate different types of communications sessions based on such requirements and configurations in a single wireless network. This may be further complicated by the various beamforming and MIMO technologies and configurations that may be available for individual combinations of devices and services.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communication network environment in which systems and techniques for dynamic beamforming configuration may be implemented, in accordance with examples of the disclosure.

FIG. 2 is a schematic diagram of an illustrative wireless communication network configuration in which systems and techniques for dynamic beamforming configuration may be implemented, in accordance with examples of the disclosure.

FIG. 3A is a schematic diagram of an illustrative wireless communication network configuration in which systems and techniques for dynamic beamforming configuration may be implemented, in accordance with examples of the disclosure.

FIG. 3B is a schematic diagram of a variation of the illustrative wireless communication network configuration of FIG. 3B in which systems and techniques for dynamic beamforming configuration may be implemented, in accordance with examples of the disclosure.

FIG. 4 is a flow diagram of an illustrative process for implementing dynamic beamforming configuration, in accordance with examples of the disclosure.

FIG. 5 is another flow diagram of an illustrative process for implementing dynamic beamforming configuration, in accordance with examples of the disclosure.

FIG. 6 is a schematic diagram of illustrative components in an example user device that is configured for dynamic beamforming configuration, in accordance with examples of the disclosure.

FIG. 7 is a schematic diagram of illustrative components in an example computing device that is configured for performing one or more aspects of dynamic beamforming configuration, in accordance with examples of the disclosure.

### DETAILED DESCRIPTION

### Overview

This disclosure is directed in part to systems and techniques for improving the performance of multiple antenna wireless communications systems in wireless communications networks and other networks that facilitate wireless communications between computing devices. Such networks include any networks that may facilitate wireless communications services for one or more wireless communications devices. Such networks include networks that support one or more 3GPP standards, including, but not limited to, Long Term Evolution (LTE) networks (e.g., 4G LTE networks), New Radio (NR) networks (e.g., 5G NR networks), and 6G networks. However, the disclosed systems and techniques may be applicable in any network or system in which a user device may request and receive access to communicate with one or more network and/or remote devices using any protocol.

In examples, the disclosed systems and techniques may enhance the performance of wireless devices and wireless communications networks that implement beamforming configurations and processes by increasing throughput and improving the efficiency of allocation of wireless communications system and device resources. In conventional systems, a wireless user device (e.g., mobile telephone, smartphone, user equipment (UE), etc.; generally referred to as “UE” herein) may wirelessly communicate with a base station (e.g., gNodeB, eNodeB, NodeB, base transceiver station (BTS), etc.) to exchange wireless communications and provide wireless communications services, such as voice, text, and data services. A modern wireless user device may be configured with multiple antennas that may be individually configurable and/or controllable to increase the bandwidth available to the device. These antennas may be controlled using various beamforming and MIMO techniques.

A wireless user device may be configured to transmit and receive wireless signals from each of the individual antennas that may be configured at the wireless user device. In examples, the wireless user device may receive beamforming configuration instructions from a base station to implement particular beamforming techniques.

For instance, a base station may instruct a wireless user device to operate using codebook-based beamforming techniques (e.g., codebook type 1 and/or type 2 beamforming techniques). In codebook-based beamforming techniques, the base station may estimate a channel quality (e.g., uplink and/or downlink channel quality, in time division duplexing (TDD) and/or frequency division duplexing (FDD)) based on a reference signal received from the wireless user device. A reference signal may be transmitted as a symbol in a slot (e.g., within a subframe of a frame) of an uplink channel. The base station may then determine, based on the estimated channel quality, a “codebook” for the wireless user device to use in implementing beamforming. A codebook may be a beamforming matrix that specifies antenna configurations for the multiple antennas configured at the wireless user device. The base station may transmit this codebook and/or other codebook-based beamforming instructions to the wireless user device for use in its beamforming configuration. In some examples, the UE may provide an indication of a beamforming matrix (e.g., as a precoding matrix indicator (PMI)) that the base station may, or may not, use to determine a codebook-based beamforming configuration.

Alternatively, a base station may instruct a wireless user device to operate using SRS-based beamforming techniques. In SRS-based beamforming techniques, the base station may estimate a channel quality (e.g., uplink and/or downlink channel quality, in TDD only in many examples) based on a reference signal received from the wireless user device. In examples, the reference signal may be a sounding reference signal (SRS), for instance, as used in 4G LTE and 5G NR systems. A reference signal may be transmitted as a symbol in a slot (e.g., within a subframe of a frame) of an uplink channel. The base station may then determine, based on the estimated channel quality, various downlink and/or uplink channel configurations for the wireless user device (e.g., configurations based on the current estimated signal reception capabilities of the wireless user device). Such configurations may include individual beam and/or antenna weighting factors. The base station may transmit the configurations and/or other SRS-based beamforming instructions to the wireless user device for use in its beamforming configuration.

In examples, SRS-based beamforming techniques may perform better as the number of antennas in use at a base station increases. For example, in current high-antenna count systems (e.g., modular massive MIMO (mmMIMO)), SRS-based beamforming techniques may provide better performance than codebook-based beamforming techniques. On the other hand, as a wireless user device travels farther from the base station, the performance of SRS-based beamforming techniques may deteriorate as the uplink signal weakens. Codebook-based beamforming techniques may provide better performance at these greater distances from the base station. To address these issues, in some conventional systems, a base station may instruct a wireless user device to switch from SRS-based beamforming operation to codebook-based beamforming operation when the wireless user device is greater than a threshold distance from the base station and vice versa.

However, these solely distance-based beamforming configuration adjustment techniques do not account for base station capacity, which may be limited based on the available beamforming technologies. For instance, a base station may be configured to support only a limited number of wireless user devices for SRS-based beamforming (e.g., 32 devices maximum, 64 devices maximum, etc.).

These distance-based beamforming configuration adjustment techniques also fail to take into account the services in use at wireless user devices. For instance, some services may require high and/or consistent data throughput (e.g., streaming applications, based on quality of service guarantees, etc.) that may be better served using SRS-based beamforming, while other, more “bursty” and/or lower throughput services may be adequately provided using codebook-based beamforming.

To address these deficiencies of conventional beamforming configuration adjustment techniques, the disclosed dynamic beamforming configuration systems and techniques may take into account multiple factors beyond device distance from a base station in determining a threshold distance for adjusting a beamforming configuration at a wireless user device. Among these factors may be one or more services currently in use at the wireless user device and the available (e.g., free) capacity at the base station.

In examples, to accommodate the various services available to wireless user devices and the corresponding configurations that may be used to implement such services, a network provider may use network “slicing” to divide a physical network infrastructure into multiple virtual networks. Each such virtual network may be configured and operated independently of other virtual networks while using the same underlying physical network infrastructure and components. Each virtual network may be referred to as a “slice” and may be identified by a data network name (DNN). In various examples, a single DNN may identify a single slice (e.g., a single virtual network); however, in other examples, a single DNN may be used to identify multiple virtual networks (e.g., may be associated with multiple slices). In such examples, and others, individual slices may be identified by a slice identifier (“slice ID”) that may be distinct from a DNN. Thus, one DNN may be associated with and support multiple slices. While the example of a single slice associated with a particular wireless user device may be used herein, it is contemplated that multiple slices may be in use at a wireless user device.

In examples, to determine a beamforming technology for use in servicing a particular wireless user device, a base station may evaluate the slice(s) in use by the wireless user device, the current beamforming capacity of the base station (e.g., maximum and currently in-use number of supported SRS-based beamforming sessions), and/or the distance between the wireless user device and the base station. Based on this evaluation, the base station may determine a current beamforming configuration for the wireless user device and/or a threshold distance from the base station at which to change the beamforming technique in use at the wireless user device.

In examples, the base station may be configured to prioritize “high data” slices (e.g., slices associated with services having high and/or consistent data throughput requirements) over “low data” slices (e.g., slices associated with services having relatively lower and/or more burst tolerant data throughput requirements) for SRS-based beamforming. For instance, for a given set of wireless user devices currently serviced by a base station, the base station may assign SRS-based beamforming resources to devices operating communications sessions in or associated with high data slices until all such devices are assigned and then assign SRS-based beamforming resources to any remaining wireless user device if there are remaining SRS-based beamforming resources.

The base station may take this approach to initially assign beamforming resources as well as to make beamforming configuration adjustments. For instance, the base station may determine a threshold distance for each wireless user device beyond which the user device will be switched to codebook-based beamforming. This threshold distance may be based on the slice(s) in which the respective wireless user device is operating. The threshold distance may also, or instead, be based on the available beamforming resources.

Upon determination of a location of the wireless user device that is equal to or greater than its determined beamforming configuration adjustment threshold distance from the base station, the base station may transmit instructions to the wireless device to adjust its beamforming configuration (e.g., from SRS-based to codebook based). Similarly, upon determination of a location of the wireless user device that is less than its determined beamforming configuration adjustment threshold distance from the base station, the base station may also transmit instructions to the wireless device to adjust its beamforming configuration (e.g., from codebook based to SRS-based).

By adjusting beamforming techniques more intelligently by taking into account various factors beyond a device's distance from a base station, the disclosed systems and techniques may provide improved service to wireless user devices and increase throughput and bandwidth utilization by ensuring high data throughput SRS-based beamforming resources are prioritized for services that require such bandwidth, while still servicing relatively lower data throughput services using codebook-based beamforming resources.

For example, the methods and systems described herein may be more efficient and/or more robust than conventional techniques, as they may increase the efficiency of wireless user device and network resource utilization by reducing unnecessary usage of SRS-based resources on the network, reserving such resources for those devices that most benefit from them. That is, the methods and systems described herein provide a technological improvement over existing systems and processes by facilitating an improved user experience and increasing device and network efficiency, reducing the use of wireless user device and common resources to provide beamforming resources that are not fully and/or properly utilized. In addition to improving the efficiency of network and device resource utilization, the systems and methods described herein can provide more robust systems by, for example, making more efficient use of network devices and user devices by reducing unnecessary and/or unproductive device and network interactions (e.g., beamforming reconfigurations), thereby freeing network and user device resources for more productive operations.

Illustrative environments, processes, and techniques for implementing systems and methods for dynamic beamforming configuration are described below. However, the described systems and techniques may be implemented in other environments.

### Illustrative System Architecture

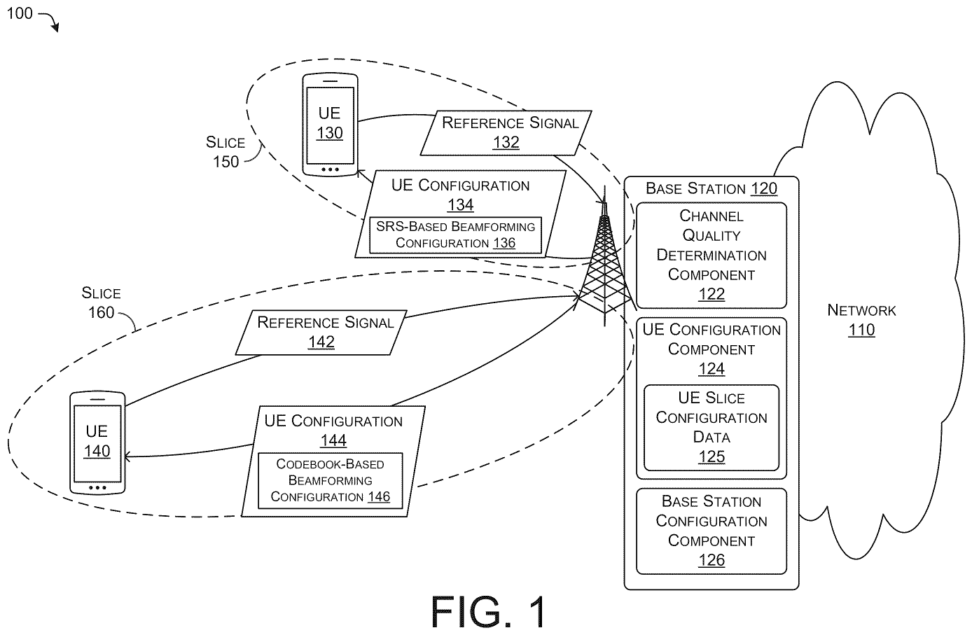

FIG. 1 is a schematic diagram of an illustrative wireless network environment 100 in which the disclosed systems and techniques may be implemented. The environment 100 may include a base station 120 that may be any type of base station, including, but not limited to, a BTS, a NodeB, an eNodeB, a gNodeB, etc. The base station 120 may communicate with other components and functions in a network 110. The network 110 may be a wireless communications network that may facilitate communication between computing devices and/or mobile devices (e.g., UEs such as UE 130 and UE 140). The network 110 may be any type of wireless communications network and may include any number and type of core and edge network components. Various connections between components and functions in the network 110 may be wired, wireless, or a combination thereof. Various connections between the network 110 and devices that communicate with the network 110 (e.g., via edge components such as base stations) may be wired, wireless, or a combination thereof. The components and functions described herein may be implemented as physical devices, as software components and/or functions executing on one or more computing devices, and as any combination thereof.

In various embodiments, the network 110 may facilitate the establishment of communications sessions for one or more wireless devices, such as a UE 130 and UE 140. In examples, the network 110 may facilitate (e.g., packet-based) communications between such wireless devices and other wireless devices, devices on the Internet, one or more systems and/or devices configured thereon, and/or one or more other (e.g., data, voice, etc.) networks.

In FIG. 1, connections between components may be logical and/or communications connections that may be facilitated by one or more wired and/or wireless connections and may include traversal of one or more devices, components, and/or functions that may or may not be shown in FIG. 1.

The UE 130 may be operating in the general vicinity of the base station 120. The UE 130 may be any type of wireless device capable of wirelessly interacting with the base station 120 (e.g., a smartphone, a cellular telephone, etc.). The UE 130 may be configured with an array of antennas and may further be configured to use various beamforming and/or MIMO techniques and technologies to transmit and receive signals using these antennas. The UE 130 may be operating a communications session in or otherwise associated with a slice 150.

The UE 140 may also be operating in the general vicinity of the base station 120. Like the UE 130, the UE 140 may be any type of wireless device capable of wirelessly interacting with the base station 120 (e.g., a smartphone, a cellular telephone, etc.). The UE 140 may be configured with an array of antennas and may further be configured to use various beamforming and/or MIMO techniques and technologies to transmit and receive signals using these antennas. The UE 140 may be operating a communications session in or otherwise associated with a slice 160. As shown in this figure, the UE 130 may be closer (e.g., in geographic distance) to the base station 120 than the UE 140.

In examples, the UE 130 may be configured to transmit, among other signals, reference signals (e.g., SRSs in uplink control information (UCI)). For example, as shown here, the UE 130 may transmit a reference signal 132 to the base station 120. Likewise, the UE 140 may be configured to transmit, among other signals, reference signals (e.g., SRSs in uplink control information (UCI)). For example, as shown here, the UE 140 may transmit a reference signal 142 to the base station 120. In examples, the reference signal 132 and/or the reference signal 142 may include a reference signal receiving power (RSRP) indicator that indicates the strength of the signal received from the base station as determined at the respective UE.

The base station 120 may be configured with various components that may perform channel quality determination and UE and base station configuration operations. For example, the base station 120 may be configured with a channel quality determination component 122 that may determine channel quality and/or characteristics for individual channels. For example, the channel quality determination component 122 may determine a channel quality for one or more channels in use by the UE 130 based on the reference signal 132. The channel quality determination component 122 may also, or instead, determine a channel quality for one or more channels in use by the UE 140 based on the reference signal 142. The channel quality determination component 122 may provide this channel quality information to a UE configuration component 124. The channel quality determination component 122 may also, or instead, provide any other information received with the reference signals 132 and/or 142 to the UE configuration component 124.

The UE configuration component 124 may determine, based on individual channel quality determinations and/or a distance of a UE from the base station 120, whether and how to instruct the UEs to configure their antennas for beamforming operations. In determining UE beamforming configurations, the UE configuration component 124 may also take into account UE slice configuration data 125 that may indicate the particular slices associated with each UE and/or other slice information, such as data throughput requirements, quality of service requirements, etc. The UE configuration component 124 may transmit UE beamforming configurations to the various UEs.

For example, the UE configuration component 124 may determine a subset of the UE slice configuration data 125 that is associated with the UE 130 (e.g., indicating that UE 130 is operating in the slice 150). This subset of the UE slice configuration data 125 may indicate that the slice 150 currently associated with the UE 130 is a high data slice. Based on this determination, the UE configuration component 124 may determine that the UE 130 is to be configured with an SRS-based beamforming configuration.

Alternatively or additionally, the UE configuration component 124 may take into account the available beamforming resource capacity at the base station 120. For instance, the UE configuration component 124 may determine whether there are sufficient available (e.g., free) SRS-based beamforming resources to assign such resources to the UE 130. Based on determining that there are sufficient SRS-based beamforming resources, the UE configuration component 124 may determine that the UE 130 is to be configured with an SRS-based beamforming configuration.

Alternatively or additionally, the UE configuration component 124 may take into account a current location of the UE 130 and a threshold distance determined based on one or more factors as described herein. For instance, the UE configuration component 124 may determine a threshold distance based on the slice 150 associated with the UE 130 and/or the available SRS-based beamforming resources. If the slice 150 is a high data slice and/or there are adequate SRS-based beamforming resources available, the UE configuration component 124 may determine a threshold distance that is relatively distant from the base station 120. On the other hand, if the slice 150 is a low data slice and/or there are inadequate SRS-based beamforming resources available, the UE configuration component 124 may determine a threshold distance that is relatively close to the base station 120. In other words, the threshold distance may increase with the data requirements of the slice and the greater availability of SRS-based beamforming resources.

The UE configuration component 124 may then determine if the UE 130 is at or beyond the threshold distance from the base station 120. Based on determining that the UE 130 is not at or beyond this threshold distance, the UE configuration component 124 may determine that the UE 130 is to be configured with an SRS-based beamforming configuration and generate an SRS-based beamforming configuration 136 that the base station 120 may transmit to the UE 130 in a UE configuration message 134.

In another example, the UE configuration component 124 may determine a subset of the UE slice configuration data 125 that is associated with the UE 140 (e.g., indicating that UE 140 is operating in the slice 160). This subset of the UE slice configuration data 125 may indicate that the slice 160 currently associated with the UE 140 is a low data slice. Based on this determination, the UE configuration component 124 may determine that the UE 140 is to be configured with a codebook-based beamforming configuration.

Alternatively or additionally, the UE configuration component 124 may take into account the available beamforming resource capacity at the base station 120. For instance, the UE configuration component 124 may determine whether there are sufficient available SRS-based beamforming resources to assign such resources to the UE 140. Based on determining that there are not sufficient SRS-based beamforming resources, the UE configuration component 124 may determine that the UE 140 is to be configured with a codebook-based beamforming configuration.

Alternatively or additionally, the UE configuration component 124 may take into account a current location of the UE 140 and a threshold distance determined based on one or more factors as described herein. For instance, the UE configuration component 124 may determine a threshold distance based on the slice 160 associated with the UE 140 and/or the available SRS-based beamforming resources. If the slice 160 is a low data slice and/or there are inadequate SRS-based beamforming resources available, the UE configuration component 124 may determine a threshold distance that is relatively close to the base station 120. On the other hand, if the slice 160 is a high data slice and/or there are adequate SRS-based beamforming resources available, the UE configuration component 124 may determine a threshold distance that is relatively distant from the base station 120. As noted above, the threshold distance may increase with the data requirements of the slice and the greater availability of SRS-based beamforming resources.

The UE configuration component 124 may then determine if the UE 140 is at or beyond the threshold distance from the base station 120. Based on determining that the UE 140 is at or beyond this threshold distance, the UE configuration component 124 may determine that the UE 140 is to be configured with a codebook-based beamforming configuration and generate a codebook-based beamforming configuration 146 that the base station 120 may transmit to the UE 140 in a UE configuration message 144.

The UE configuration component 124 may provide determined UE beamforming configurations to a base station confirmation component 126 to allow the base station 120 to be properly configured to interact with the UEs using the determined beamforming techniques. Alternatively or additionally, the base station confirmation component 126 may independently determine a beamforming configuration for each UE to apply at the base station 120.

By intelligently determining beamforming configurations for the UE 130 and the UE 140 using factors that take into account the individual requirements of the UEs and the resources available at the base station 120, as well as the distances between the UEs and the base station, the base station 120 may improve the service provided to the UEs as well as making more efficient use of beamforming, power, and network resources than if the base station determined beamforming configurations based solely on distances between it and the UEs. For example, the base station 120 may avoid wasting SRS-based beamforming resources (that may be more power, memory, and processor intensive than codebook beamforming resources) to UEs that may provide the same level of service using codebook-based beamforming resources. The base station 120 may further provide improved service to UEs that truly benefit from (or require) higher data throughput by ensuring that those UEs receive SRS-based beamforming resources for longer distances (and therefore longer periods of time).

### Illustrative Network Configurations

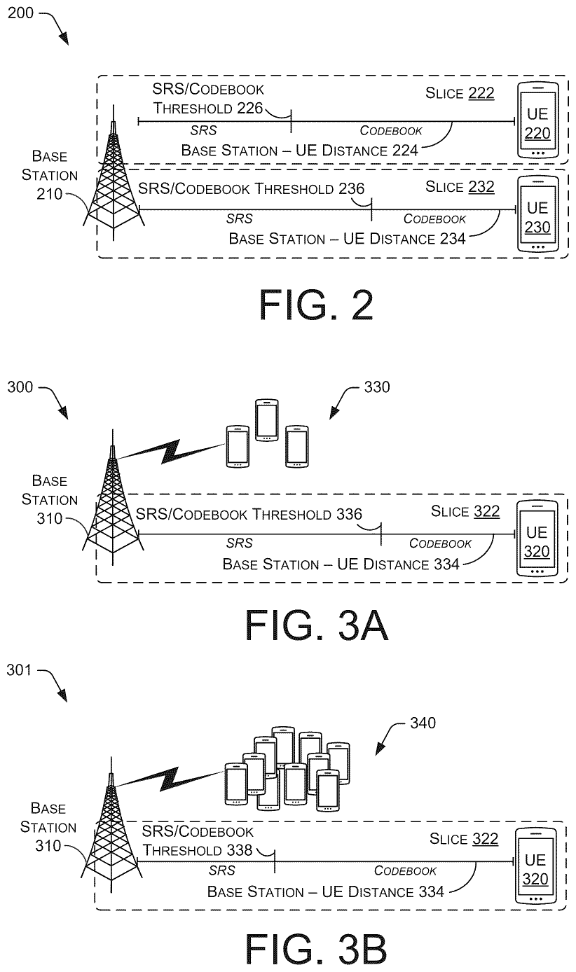

FIG. 2 is a schematic diagram of an illustrative wireless network configuration 200 in which the disclosed systems and techniques may be implemented. The configuration 200 may include a base station 210 that may be any type of base station, including, but not limited to, a BTS, a NodeB, an eNodeB, a gNodeB, etc. The base station 210 may include any base station components described herein and may perform any of the base station operations described herein, including the components and operations described above in regard to the base station 120. The base station 210 may be communicating with a UE 220 and a UE 230. The UEs 220 and 230 may be any type of UE and may include any UE components described herein and may perform any of the UE operations described herein, including the components and operations described above in regard to the UE 130 and the UE 140.

As described herein, a base station may determine, for a particular UE, a threshold distance at which the base station may instruct a UE to change its beamforming configuration. For example, the UE 220 may be in communication with the base station 210. The UE 220 may be a distance 224 from the base station 210. As indicated in this figure, this distance 224 may include an SRS zone, in which the UE will be configured to operate using SRS-based beamforming, and a codebook zone, in which the UE will be configured to operate using codebook-based beamforming. The base station 210 may determine the distance 224 from an RSRP indicated by the UE 220. The UE 220 may be operating one or more communications sessions in or associated with a slice 222.

In examples, the distance 224 (and similar distances described herein) may be determined based on timing advance (TA) and an RSRP. For instance, the based station may execute a localization operation using the TA and the RSRP measurements (or a combination thereof) to infer the location of the UE 220, which may then be used to determine the distance 224.

Based on the type of slice 222, the base station 210 may determine an SRS/codebook threshold 226. For example, the SRS/codebook threshold 226 may be located at a specific location of the distance 224 based on the type of slice. For instance, a low data slice may have a threshold 226 set at a first location along the distance 224 (e.g., at 25%, 40%, 50%, etc., of the distance 224 from the base station, a center point of the distance 224, etc.) that may be closer to the base station than the position of the threshold 226 for a high data slice. A high data slice may have a threshold 226 set at a second location along the distance 224 (e.g., at 50%, 60%, 75%, etc., of the distance 224 from the base station, a center point of the distance 224, etc.) that is farther from the base station than the position of the threshold 226 for a low data slice.

The SRS/codebook threshold 226 may serve as the demarcation point between the SRS zone and the codebook zone. For instance, the base station 210 may determine that the slice 222 is a low data slice or otherwise tolerant of traffic bursts and/or latency. Based on this determination, the base station 210 may determine a location for the SRS/codebook threshold 226 that is relatively close to the base station 210, allowing the base station 210 to instruct the UE 220 to switch to codebook-based beamforming relatively close to the base station 210.

The UE 230 may also be in communication with the base station 210. The UE 230 may be a distance 234 from the base station 210. Here again, the base station 210 may determine the distance 234 from an RSRP indicated by the UE 230. As indicated in this figure, this distance 234 may include an SRS zone, in which the UE will be configured to operate using SRS-based beamforming, and a codebook zone, in which the UE will be configured to operate using codebook-based beamforming. The UE 230 may be operating one or more communications sessions in or associated with a slice 232.

Based on the type of slice 232, the base station 210 may determine an SRS/codebook threshold 236 that may serve as the boundary between the SRS zone and the codebook zone. For instance, the base station 210 may determine that the slice 232 is a high data slice or otherwise requires relatively higher data throughput than, for example, the slice 222. Based on this determination, the base station 210 may determine a location for the SRS/codebook threshold 236 that is relatively distant from the base station 210, allowing the base station 210 to instruct the UE 230 to switch to codebook-based beamforming relatively farther from the base station 210 than it would instruct the UE 220 based on the SRS/codebook threshold 226.

As shown here, the low data slice 222 influences the determination of the base station 210 of a position of the SRS/codebook threshold 226 that is closer to the base station 210. This allows the use of codebook-based beamforming for the UE 220 sooner (e.g., as it moves away from the base station 210) and the delayed use of SRS-based beamforming for the UE 220 (e.g., as it moves towards the base station 210). This frees up SRS-based beamforming resources for use with UEs associated with slices that have higher data throughput requirements.

In contrast, the high data slice 232 influences the determination of the base station 210 of a position of the SRS/codebook threshold 236 that is farther from the base station 210. This delays the use of codebook-based beamforming for the UE 230 (e.g., as it moves away from the base station 210) and facilitates the use of SRS-based beamforming for the UE 230 sooner (e.g., as it moves towards the base station 210). This ensures that SRS-based beamforming resources are provided expediently for use with UEs associated with slices that have higher data throughput requirements.

FIG. 3A is a schematic diagram of an illustrative wireless network configuration 300 in which the disclosed systems and techniques may be implemented. The configuration 300 may include a base station 310 that may be any type of base station, including, but not limited to, a BTS, a NodeB, an eNodeB, a gNodeB, etc. The base station 310 may include any base station components described herein and may perform any of the base station operations described herein, including the components and operations described above in regard to the base station 120. The base station 310 may be communicating with a UE 320. The UE 320 may be any type of UE and may include any UE components described herein and may perform any of the UE operations described herein, including the components and operations described above in regard to the UE 130 and the UE 140.

As noted, a base station may determine, for a particular UE, a threshold distance at which the base station may instruct a UE to change its beamforming configuration. For example, the UE 320 may be a distance 334 from the base station 310. As indicated in this figure, this distance 334 may include an SRS zone, in which the UE will be configured to operate using SRS-based beamforming, and a codebook zone, in which the UE will be configured to operate using codebook-based beamforming. The base station 310 may determine the distance 334 from an RSRP indicated by the UE 320. The UE 320 may be operating one or more communications sessions in or associated with a slice 322.

The base station 310 may also be in communication with one or more other UEs 330. Individual UEs of the UEs 330 may be communicating with the base station 310 using SRS-based beamforming techniques or codebook-based beamforming techniques. In this example, the base station 310 may have a limited quantity of SRS-based beamforming resources available, and the UEs 330 may be consuming a relatively small portion of those SRS-based beamforming resources, leaving plentiful remaining SRS-based beamforming resources.

Based on the available SRS-based beamforming resources, the base station 310 may determine an SRS/codebook threshold 336 that may serve as a boundary between the SRS zone and the codebook zone. For instance, the base station 310 may determine that the available SRS-based beamforming resources are greater than a threshold quantity of resources (e.g., more than 25%, 35%, 50%, etc., of the SRS-based beamforming resources are available). Based on this determination, the base station 310 may determine a location for the SRS/codebook threshold 336 that is relatively distant from the base station 310, allowing the base station 310 to instruct the UE 320 to switch to codebook-based beamforming relatively farther from the base station 310 than if there were fewer resources available. In this way, SRS-based beamforming resources may be maintained longer and/or farther for the UE 320, which may be acceptable because there may be less demand for SRS-based beamforming resources due to the relatively small quantity of UEs 330.

For example, the SRS/codebook threshold 336 may be located at specific locations of the distance 334 based on particular quantities of SRS-based beamforming resources. For instance, if 25% of such resources area available, a threshold 336 may be set at a first location along the distance 334 (e.g., at 25%, 40%, 50%, etc., of the distance 334 from the base station, a center point of the distance 334, etc.) that may be closer to the base station than the position of the threshold 336 for a greater quantity of available SRS-based beamforming resources. If 75% of such resources area available, a threshold 336 set at a second location along the distance 334 (e.g., at 50%, 60%, 75%, etc., of the distance 334 from the base station, etc.) that is farther from the base station than the position of the threshold 336 for a smaller quantity of available SRS-based beamforming resources.

Note that such factors may be used in combination with slice factors. For instance, the base station may average a weight, distance, or value associated with a slice (e.g., 50% of the base station-UE distance) and a weight, distance, or value associated with a quantity of SRS-based beamforming resources (e.g., 25% of the base station-UE distance) to determine a value used to locate an SRS/codebook threshold (e.g., (50%+25%)/2=37.5% in this example). In this case, the base station would locate the SRS/codebook threshold at a point that is 37.5% of the distance from the base station to the UE.

Note that this determination may be combined with the slice determination described herein (e.g., in regard to FIG. 2). For instance, the base station 310 may only determine SRS/codebook threshold 336 based on available SRS-based beamforming resources if the slice 322 is a high data slice. Alternatively, the base station 310 may determine SRS/codebook threshold 336 by weighting a value representing the available SRS-based beamforming resources higher if the slice 322 is a high data slice, using a lower weight if the slice is a low data slice. Various other permutations of factors may be used to determine the SRS/codebook threshold 336 and are contemplated as within the scope of the instant disclosure.

FIG. 3B is a schematic diagram of an illustrative wireless network configuration 301 that is similar to configuration 300 of FIG. 3A. In configuration 301, the base station 310 may be in communication with one or more other UEs 340 that may be a larger quantity of UEs than the UEs 330 of configuration 300. As with configuration 300, individual UEs of the UEs 340 may be communicating with the base station 310 using SRS-based beamforming techniques or codebook-based beamforming techniques. In this example, the UEs 340 may be consuming a relatively large portion of the SRS-based beamforming resources, leaving fewer remaining SRS-based beamforming resources than in configuration 300.

Based on the available SRS-based beamforming resources, the base station 310 may determine an SRS/codebook threshold 338. For instance, the base station 310 may determine that the available SRS-based beamforming resources are less than a threshold quantity of resources (e.g., more than 25%, 35%, 50%, etc., of the SRS-based beamforming resources are available). Based on this determination, the base station 310 may determine a location for the SRS/codebook threshold 338 that is relatively close to the base station 310, allowing the base station 310 to instruct the UE 320 to switch to codebook-based beamforming relatively closer to the base station 310 than if there were more resources available. In this way, SRS-based beamforming resources may be freed up for other devices, which may be beneficial because SRS-based beamforming resources may perform better closer to the base station 310 and there may be more demand for such resources due to the greater quantity of UEs 340.

Here again, this determination may be combined with the slice determination described herein (e.g., in regard to FIG. 2). For instance, the base station 310 may only determine SRS/codebook threshold 338 based on available SRS-based beamforming resources if the slice 322 is a high data slice. Alternatively, the base station 310 may determine SRS/codebook threshold 338 by weighting a value representing the available SRS-based beamforming resources higher if the slice 322 is a high data slice, using a lower weight if the slice is a low data slice. Various other permutations of factors may be used to determine the SRS/codebook threshold 338 and are contemplated as within the scope of the instant disclosure.

Note that in other examples, a contrasting operation may be performed based on the quantity of available SRS-based beamforming resources. That is, if many or most SRS-based beamforming resources are in use (e.g., greater than a threshold quantity of resources (e.g., more than 25%, 35%, 50%, etc., of the SRS-based beamforming resources are available)), an SRS/codebook threshold may be set farther from the base station (e.g., as in FIG. 3A) so that such resources may be retained by a UE in a high SRS-based beamforming resource demand environment. This may be especially beneficial when the UE is associated with a high data slice to help ensure that the UE does not lose access to SRS-based beamforming resources.

### Illustrative Operations

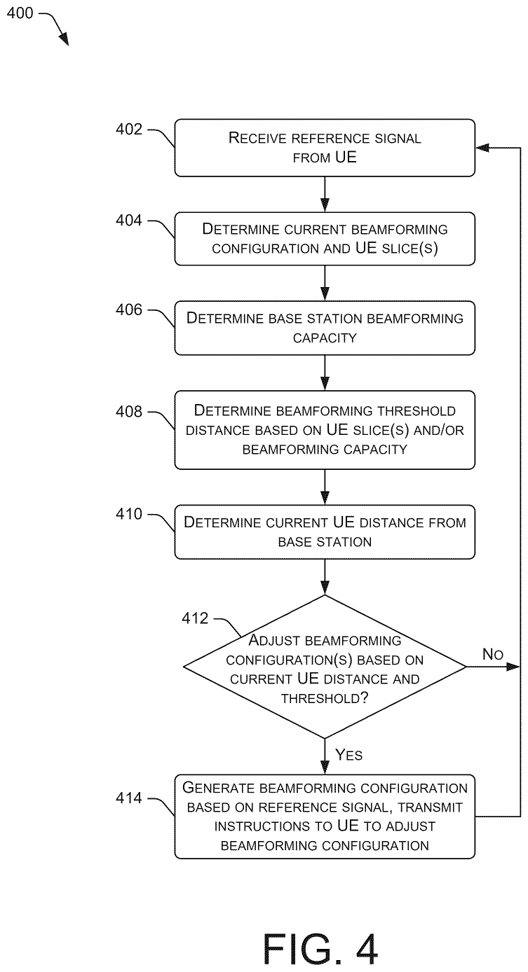

FIG. 4 shows a flow diagram of an illustrative process 400 for determining, at a base station or other network system, UE beamforming configurations based on received reference signals and various other factors according to the disclosed embodiments. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIG. 1; however, other environments may also be used.

At block 402, a base station (e.g., base station 120) or other network system may receive a reference signal transmission, such as an SRS transmission (e.g., 4G SRS transmission, 5G SRS transmission, 6G SRS transmission, etc.), from a UE (e.g., UE 130 or UE 140). Any other type of reference signal and/or data may be received from a UE, and any such data may be used to determine channel quality. This channel quality may then be used to determine a suitable beamforming configuration to transmit to the UE (e.g., a codebook-based beamforming configuration or an SRS-based beamforming configuration).

At block 404, the base station may determine current UE configuration data for the UE. For example, the base station may determine the current beamforming configuration (e.g., codebook-based beamforming configuration or SRS-based beamforming configuration). The base station may also, or instead, determine one or more slices (e.g., one or more virtual networks) associated with the UE. As noted above, the base station may determine such information from UE configuration data, such as the UE slice configuration data 125. Included in the determination of block 404 may be a determination of a slice type. A slice type may be a high data slice type or low data slice type as described above. Alternatively or additionally, slice types may be priorities (e.g., higher priority for slices with higher throughput requirements, lower priority for slices with lower throughput requirements, etc.), rankings, scores, weightings, etc.

At block 406, the base station may determine the current base station beamforming capacity. In examples, this may be the current quantity of available SRS-based beamforming resources from among all SRS-based beamforming resources configured at the base station. For instance, the base station may determine that 16 of 32 SRS-based beamforming resources are available (and, accordingly, 16 are in use), where an individual SRS-based beamforming resource can service one UE. The base station may determine this as quantities of resources (16 of 32), percentage (50% available in the 16 of 32 example), and/or any effective indicator of a quantity of available SRS-based beamforming resources (SRS-based beamforming resources not currently in use). The quantity of SRS-based beamforming resources available to the base station may be dependent on, or related to, a quantity of UEs that are in communications with the base station. Accordingly, when the base station ceases communications with one or more UEs, the base station may determine that is a change in the quantity in the form of more resources for one or more remaining UEs that are still in communications with the base station. Conversely, when the base station establishes communications with one or more new UEs, the base station may determine that there is a change in the quantity in the form of fewer resources for the UEs that are already in communications with the base station. The base station may also, or instead, determine if a quantity of resources meets or exceeds a resource quantity threshold.

At block 408, the base station may determine a beamforming threshold distance (e.g., SRS/codebook threshold 226, 336, or 338) for the UE based on the slice (e.g., slice type) and/or the available SRS-based beamforming resources. For example, as described herein, the base station may increase the distance between the base station and the beamforming threshold distance for high data slices and/or based on available SRS-based beamforming resources (e.g., if a quantity of resources meets or exceeds a resource quantity threshold) and decrease the distance for low data slices and/or based on available SRS-based beamforming resources (e.g., if a quantity of resources falls below a resource quantity threshold). In examples, values representing the slice and/or the available SRS-based beamforming resources may be weighted based on various criteria and used to determine an ultimate beamforming threshold distance or location.

At block 410, the base station may determine a current location of the UE and/or a current distance of the UE from the base station. In examples, this may be performed using an indication of the RSRP that was received from the UE. Based on this signal power indication, the base station may determine an approximate distance of the UE from the base station.

At block 412, the base station determine whether to adjust the current beamforming configuration of the UE. For example, the system may determine if the UE is located in a beamforming configuration zone associated with its current configuration or if it has crossed the beamforming threshold. For instance, if the UE is currently operating with an SRS-based beamforming configuration and, based on its threshold determined at block 408, is currently located in an SRS zone, no change is needed to the UE. However, if the UE is currently operating with an SRS-based beamforming configuration and, based on its threshold determined at block 408, is currently located in a codebook zone, the base station may determine that a beamforming configuration adjustment is needed. In another instance, if the UE is currently operating with a codebook-based beamforming configuration and, based on its threshold determined at block 408, is currently located in a codebook zone, no change is needed to the UE. However, if the UE is currently operating with a codebook-based beamforming configuration and, based on its threshold determined at block 408, is currently located in an SRS zone, the base station may determine that a beamforming configuration adjustment is needed.

If no adjustment is needed, the base station may return to block 402 of the process 400 to continue to evaluate subsequent reference signals.

If the base station determines, at block 412, that a beamforming configuration is warranted, at block 414, the base station may generate a beamforming configuration, for example, based on the reference signal received at block 402. For instance, if the UE is currently operating with an SRS-based beamforming configuration and, based on its threshold determined at block 408, is currently located in a codebook zone, the base station may generate a codebook-based beamforming configuration using the reference signal received at block 402. The base station may transmit instructions to the UE to implement the generated beamforming configuration. In another instance, if the UE is currently operating with a codebook-based beamforming configuration and, based on its threshold determined at block 408, is currently located in an SRS zone, the base station may generate an SRS-based beamforming configuration using the reference signal received at block 402. The base station may transmit instructions to the UE to implement the generated beamforming configuration.

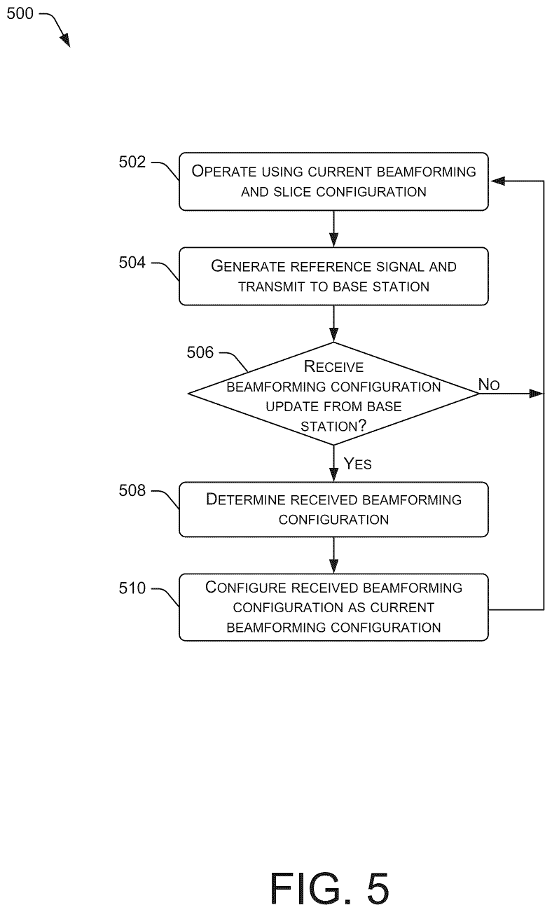

FIG. 5 shows a flow diagram of an illustrative process 500 for receiving beamforming configuration instructions and implementing a beamforming configuration at a UE according to the disclosed embodiments. The process 500 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 500 may be described with reference to the wireless network environment 100 of FIG. 1; however, other environments may also be used.

At block 502, a UE may operate using a current beamforming and slice configuration. For example, upon establishing a communications session with a base station, the base station may provide the UE with an initial beamforming configuration (e.g., an SRS-based beamforming configuration or a codebook-based beamforming configuration). Alternatively, the base station may have transmitted one or more subsequent beamforming configurations to the UE (e.g., as the UE passed from one beamforming zone to another). Similarly, during the course of normal operation, the UE may initiate communications using one or more slices.

At block 504, the UE (e.g., UE 130 or UE 140) may generate a reference signal transmission, such as an SRS transmission (e.g., 4G SRS transmission, 5G SRS transmission, 6G SRS transmission, etc.) and transmit the reference signal to the base station.

At block 506, the UE may determine whether a beamforming configuration update has been received from the base station. If not, or if a beamforming configuration update has been received that is substantially identical to the UE's current beamforming configuration, the UE may return to block 502 of the process 500 to continue operating using the current beamforming configuration and slice(s).

If, at block 506, the UE received a beamforming configuration update from the base station, at block 508, the UE may determine the updated beamforming configuration from the update received at block 506. For example, the UE may determine the codebook if the received configuration is a codebook-based beamforming configuration or the SRS-based beamforming parameters for an SRS-based beamforming configuration.

At the block 510, the UE may implement the received beamforming configuration as its current beamforming configuration. The UE may then return to block 502 of the process 500 to resume operating using the (updated) current beamforming configuration and slice(s)

In summary, by generating intelligent beamforming configuration adjustment criteria for UEs, the disclosed systems and techniques may be able to increase the efficiency of usage of UE and base station resources, improving the user experience and performance of both the network and user devices.

### Example User Equipment

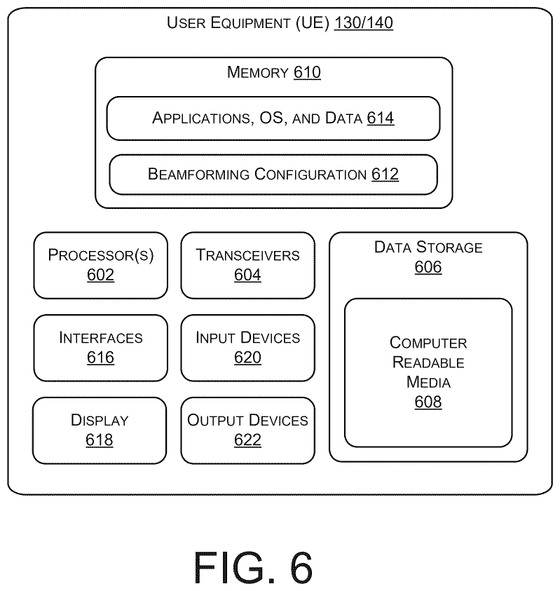

FIG. 6 is an example of a UE, such as UE 130 or UE 140, for use with the systems and methods disclosed herein, in accordance with some examples of the present disclosure.

The UE 130/140 may include one or more processors 602, one or more transmit/receive antennas (e.g., transceivers or transceiver antennas) 604, and a data storage 606. The data storage 606 may include a computer-readable media 608 in the form of memory and/or cache. This computer-readable media may include a non-transitory computer-readable media. The processor(s) 602 may be configured to execute instructions, which can be stored in the computer-readable media 608 and/or in other computer-readable media accessible to the processor(s) 602. In some configurations, the processor(s) 602 is a Central Processing Unit (CPU), a Graphics Processing Unit (GPU), or both CPU and GPU, or any other sort of processing unit. The transceiver antenna(s) 604 can exchange signals with a base station, such as base station 120.

The UE 130/140 may be configured with a memory 610. The memory 610 may be implemented within, or separate from, the data storage 606 and/or the computer-readable media 608. The memory 610 may include any available physical media accessible by a computing device to implement the instructions stored thereon. For example, the memory 610 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 130/140.

The memory 610 can store several modules, such as instructions, data stores, and so forth that are configured to execute on the processor(s) 602. In configurations, the memory 610 may also store one or more applications 614 configured to receive and/or provide voice, data, and messages (e.g., SMS messages, Multi-Media Message Service (MMS) messages, Instant Messaging (IM) messages, Enhanced Message Service (EMS) messages, one or more dialers and related components, etc.) to and/or from another device or component (e.g., the base station 120). The applications 614 may also include one or more operating systems and/or one or more third-party applications that provide additional functionality to the UE 130/140. The applications 614 may also include antenna-related components, such as the beamforming configuration component 612 that may be configured to perform any of the beamforming configuration operations described herein. The memory may also, or instead, store bandwidth information, such as UE-supported bands, bandwidth(s), and bandwidth parts, one or more IP addresses, indications of sets of IP addresses, as well as communications session information such as UE-specific carrier bandwidth(s). The memory may also, or instead, antenna configuration information, session management component information, user plane component information, policy component information, etc.

Although not all illustrated in FIG. 6, the UE 130/140 may also comprise various other components, e.g., a battery, a charging unit, one or more network interfaces 616, an audio interface, a display 618, a keypad or keyboard, and one or more input devices 620, and one or more output devices 622.

### Example Computing Device

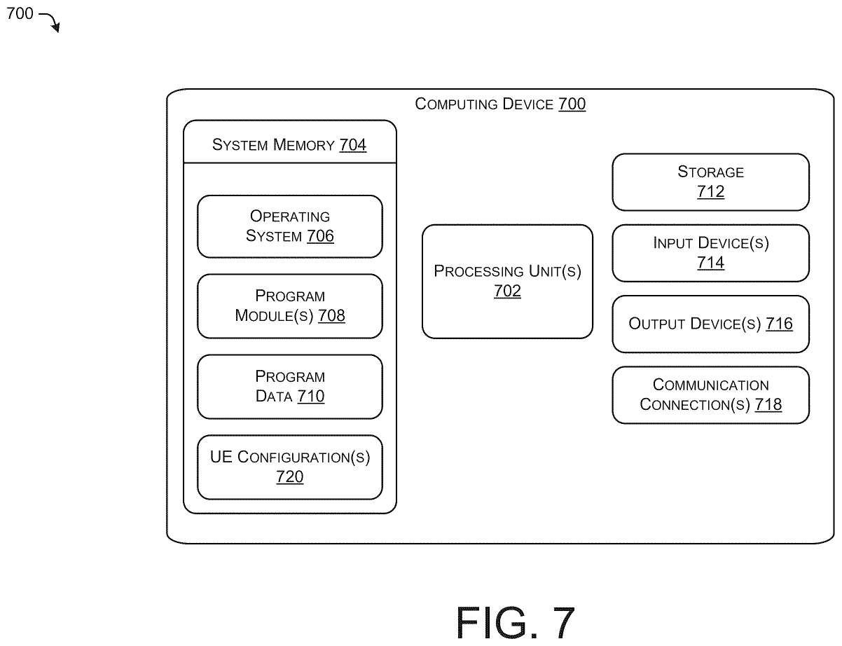

FIG. 7 is an example of a computing device 700 for use with the systems and methods disclosed herein, in accordance with some examples of the present disclosure. The computing device 700 can be used to implement various components of a core network, a base station (e.g., base station 120), and/or any servers, routers, gateways, gateway elements, administrative components, network components, etc. that can be used by a communication provider.

In various embodiments, the computing device 700 can include one or more processing units 702 and system memory 704. Depending on the exact configuration and type of computing device, the system memory 704 can be volatile (such as RAM), non-volatile (such as ROM, flash memory, etc.) or some combination of the two. The system memory 704 can include an operating system 706, one or more program modules 708 (e.g., channel quality determination component(s) and/or module(s), UE configuration component(s) and/or module(s), base station configuration component(s) and/or module(s)), program data 710, and UE configuration data 720. The system memory 704 may be secure storage or at least a portion of the system memory 704 can include secure storage. The secure storage can prevent unauthorized access to data stored in the secure storage. For example, data stored in the secure storage can be encrypted or accessed via a security key and/or password.

The computing device 700 can also include additional data storage devices (removable and/or non-removable) such as, for example, magnetic disks, optical disks, or tape. Such additional storage is illustrated in FIG. 7 by storage 712.

The computing device 700 may store, in either or both of the system memory 704 and the storage 712, beamforming information, antenna information, antenna configuration information, UE information, location information, IP addresses, IP address data, timer information and/or timestamps, message transfer data, session management data, etc.

Non-transitory computer storage media of the computing device 700 can include volatile and nonvolatile, removable and non-removable media implemented in any method or technology for storage of information, such as computer-readable instructions, data structures, program modules, or other data. The system memory 704 and storage 712 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 700. Any such non-transitory computer-readable storage media can be part of the computing device 700.

In various embodiments, any or all of the system memory 704 and storage 712 can store programming instructions which, when executed, implement some or all of the functionality described above as being implemented by one or more systems configured in the environment 100 and/or components of the network 110.

The computing device 700 can also have one or more input devices 714 such as a keyboard, a mouse, a touch-sensitive display, voice input device, etc. The computing device 700 can also have one or more output devices 716 such as a display, speakers, a printer, etc. can also be included. The computing device 700 can also contain one or more communication connections 718 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.
A: A method performed by a wireless network base station, the method comprising communicating with a mobile device using sounding reference signal-based beamforming; determining, based at least in part on a signal received from the mobile device, a distance between the mobile device and the wireless network base station; determining a virtual network associated with the mobile device; determining a quantity of sounding reference signal-based beamforming resources available at the wireless network base station; determining, based at least in part on the virtual network and the quantity of sounding reference signal-based beamforming resources, a threshold distance; determining that the distance between the mobile device and the wireless network base station meets or exceeds the threshold distance; generating, based at least in part on determining that the distance between the mobile device and the wireless network base station meets or exceeds the threshold distance, a codebook-based beamforming configuration; and transmitting the codebook-based beamforming configuration to the mobile device.
B. The method of paragraph A, further comprising: ceasing communications with one or more additional mobile devices; based at least in part on ceasing communications with the one or more additional mobile devices, determining a second quantity of sounding reference signal-based beamforming resources available at the wireless network base station; and determining, based at least in part on the virtual network and the quantity of sounding reference signal-based beamforming resources, a second threshold distance.
C: The method of paragraph B 2, further comprising: determining, based at least in part on a second signal received from the mobile device, a second distance between the mobile device and the wireless network base station; determining that the second distance between the mobile device and the wireless network base station does not exceed the second threshold distance; generating, based at least in part on determining that the distance between the mobile device and the wireless network base station does not exceed the threshold distance, a sounding reference signal-based beamforming configuration; and transmitting the sounding reference signal-based beamforming configuration to the mobile device.
D: The method of any of paragraphs A-C, further comprising: establishing communications with one or more additional mobile devices; based at least in part on establishing communications with the one or more additional mobile devices, determining a second quantity of sounding reference signal-based beamforming resources available at the wireless network base station; and determining, based at least in part on the virtual network and the quantity of sounding reference signal-based beamforming resources, a second threshold distance.
E: The method of paragraphs E, further comprising: determining, based at least in part on a second signal received from the mobile device, a second distance between the mobile device and the wireless network base station; determining that the second distance between the mobile device and the wireless network base station meets or exceeds the second threshold distance; and communicating with the mobile device using codebook-based beamforming.
F: The method of any of paragraphs A-E, wherein the signal received from the mobile device comprises a reference signal received power (RSRP) indicator.
G: The method of any of paragraphs A-F, wherein the signal received from the mobile device comprises a sounding reference signal (SRS).
H: A wireless network base station, comprising: one or more processors; a plurality of antennas; and non-transitory computer-readable media storing computer-executable instructions that, when executed by the one or more processors, cause the one or more processors to perform operations comprising: communicating with a mobile device using a first beamforming technique; determining, based at least in part on a signal received from the mobile device, a distance between the mobile device and the wireless network base station; determining a virtual network associated with the mobile device; determining a quantity of beamforming resources associated with the first beamforming technique and available at the wireless network base station; determining, based at least in part on the virtual network and the quantity of beamforming resources, a threshold distance; determining that the distance between the mobile device and the wireless network base station meets or exceeds the threshold distance; generating, based at least in part on determining that the distance between the mobile device and the wireless network base station meets or exceeds the threshold distance, a beamforming configuration associated with a second beamforming technique distinct from the first beamforming technique; and transmitting the beamforming configuration to the mobile device.
I: The wireless network base station of paragraph H, wherein the signal received from the mobile device comprises a reference signal received power (RSRP) indicator.
J: The wireless network base station of paragraph H or I, wherein the signal received from the mobile device comprises a sounding reference signal (SRS).
K: The wireless network base station of any of paragraphs H-J, wherein determining the threshold distance comprises: determining that the quantity of beamforming resources meets or exceeds a resource quantity threshold; and determining the threshold distance further based at least in part on determining that the quantity of beamforming resources meets or exceeds the resource quantity threshold.
L: The wireless network base station of any of paragraphs H-K, wherein determining the threshold distance comprises: determining that the virtual network is a high data throughout virtual network; and determining the threshold distance further based at least in part on determining that the virtual network is the high data throughout virtual network.
M: The wireless network base station of paragraph L, wherein determining the threshold distance further comprises increasing the threshold distance based at least in part on determining that the virtual network is the high data throughout virtual network.
N: The wireless network base station of any of paragraphs H-M, wherein the operations further comprise: establishing communications with one or more additional mobile devices; based at least in part on establishing communications with the one or more additional mobile devices, determining a second quantity of beamforming resources associated with the first beamforming technique and available at the wireless network base station; determining, based at least in part on the virtual network and the second quantity of beamforming resources, a second threshold distance; determining, based at least in part on a second signal received from the mobile device, a second distance between the mobile device and the wireless network base station; determining that the second distance between the mobile device and the wireless network base station meets or exceeds the second threshold distance; and communicating with the mobile device using the second beamforming technique.
O: A non-transitory computer-readable media storing computer-executable instructions that, when executed by one or more processors, cause the one or more processors configured at a wireless network base station to perform operations comprising: communicating with a mobile device using a first beamforming technique; determining, based at least in part on a signal received from the mobile device, a distance between the mobile device and the wireless network base station; determining a virtual network associated with the mobile device; determining a quantity of beamforming resources associated with the first beamforming technique and available at the wireless network base station; determining, based at least in part on the virtual network and the quantity of sounding reference signal-based beamforming resources, a threshold distance; determining that the distance between the mobile device and the wireless network base station meets or exceeds the threshold distance; generating, based at least in part on determining that the distance between the mobile device and the wireless network base station meets or exceeds the threshold distance, a beamforming configuration associated with a second beamforming technique distinct from the first beamforming technique; and transmitting the beamforming configuration to the mobile device.
P: The non-transitory computer-readable media of paragraph O, wherein the signal received from the mobile device comprises a reference signal received power (RSRP) indicator.
Q: The non-transitory computer-readable media of paragraph O or P, wherein the signal received from the mobile device comprises a sounding reference signal (SRS).
R: The non-transitory computer-readable media of any of paragraphs O-Q, wherein determining the threshold distance comprises: determining that the quantity of beamforming resources falls below a resource quantity threshold; and determining the threshold distance further based at least in part on determining that the quantity of beamforming resources falls below the resource quantity threshold.
S: The non-transitory computer-readable media of any of paragraphs O-R, wherein determining the threshold distance comprises: determining that the virtual network is a low data throughout virtual network; and determining the threshold distance further based at least in part on determining that the virtual network is the low data throughout virtual network.
T: The non-transitory computer-readable media of paragraph S, wherein determining the threshold distance further comprises reducing the threshold distance based at least in part on determining that the virtual network is the low data throughout virtual network.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### Conclusion

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), 6G, Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes that come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by a wireless network base station, the method comprising:
communicating with a mobile device using sounding reference signal-based beamforming;
determining, based at least in part on a signal received from the mobile device, a distance between the mobile device and the wireless network base station;
determining a virtual network associated with the mobile device;
determining a quantity of sounding reference signal-based beamforming resources available at the wireless network base station;
determining, based at least in part on the virtual network and the quantity of sounding reference signal-based beamforming resources, a threshold distance;
determining that the distance between the mobile device and the wireless network base station meets or exceeds the threshold distance;
generating, based at least in part on determining that the distance between the mobile device and the wireless network base station meets or exceeds the threshold distance, a codebook-based beamforming configuration; and
transmitting the codebook-based beamforming configuration to the mobile device.

2. The method of claim 1, further comprising:
ceasing communications with one or more additional mobile devices;
based at least in part on ceasing communications with the one or more additional mobile devices, determining a second quantity of sounding reference signal-based beamforming resources available at the wireless network base station; and
determining, based at least in part on the virtual network and the quantity of sounding reference signal-based beamforming resources, a second threshold distance.

3. The method of claim 2, further comprising:
determining, based at least in part on a second signal received from the mobile device, a second distance between the mobile device and the wireless network base station;
determining that the second distance between the mobile device and the wireless network base station does not exceed the second threshold distance;
generating, based at least in part on determining that the distance between the mobile device and the wireless network base station does not exceed the threshold distance, a sounding reference signal-based beamforming configuration; and
transmitting the sounding reference signal-based beamforming configuration to the mobile device.

4. The method of claim 1, further comprising:
establishing communications with one or more additional mobile devices;
based at least in part on establishing communications with the one or more additional mobile devices, determining a second quantity of sounding reference signal-based beamforming resources available at the wireless network base station; and
determining, based at least in part on the virtual network and the quantity of sounding reference signal-based beamforming resources, a second threshold distance.

5. The method of claim 4, further comprising:
determining, based at least in part on a second signal received from the mobile device, a second distance between the mobile device and the wireless network base station;
determining that the second distance between the mobile device and the wireless network base station meets or exceeds the second threshold distance; and
communicating with the mobile device using codebook-based beamforming.

6. The method of claim 1, wherein the signal received from the mobile device comprises a reference signal received power (RSRP) indicator.

7. The method of claim 1, wherein the signal received from the mobile device comprises a sounding reference signal (SRS).

8. A wireless network base station, comprising:
one or more processors;
a plurality of antennas; and
non-transitory computer-readable media storing computer-executable instructions that, when executed by the one or more processors, cause the one or more processors to perform operations comprising:
communicating with a mobile device using a first beamforming technique;
determining, based at least in part on a signal received from the mobile device, a distance between the mobile device and the wireless network base station;
determining a virtual network associated with the mobile device;
determining a quantity of beamforming resources associated with the first beamforming technique and available at the wireless network base station;
determining, based at least in part on the virtual network and the quantity of beamforming resources, a threshold distance;
determining that the distance between the mobile device and the wireless network base station meets or exceeds the threshold distance;
generating, based at least in part on determining that the distance between the mobile device and the wireless network base station meets or exceeds the threshold distance, a beamforming configuration associated with a second beamforming technique distinct from the first beamforming technique; and
transmitting the beamforming configuration to the mobile device.

9. The wireless network base station of claim 8, wherein the signal received from the mobile device comprises a reference signal received power (RSRP) indicator.

10. The wireless network base station of claim 8, wherein the signal received from the mobile device comprises a sounding reference signal (SRS).

11. The wireless network base station of claim 8, wherein determining the threshold distance comprises:
determining that the quantity of beamforming resources meets or exceeds a resource quantity threshold; and
determining the threshold distance further based at least in part on determining that the quantity of beamforming resources meets or exceeds the resource quantity threshold.

12. The wireless network base station of claim 8, wherein determining the threshold distance comprises:
determining that the virtual network is a high data throughout virtual network; and
determining the threshold distance further based at least in part on determining that the virtual network is the high data throughout virtual network.

13. The wireless network base station of claim 12, wherein determining the threshold distance further comprises increasing the threshold distance based at least in part on determining that the virtual network is the high data throughout virtual network.

14. The wireless network base station of claim 8, wherein the operations further comprise:
establishing communications with one or more additional mobile devices;
based at least in part on establishing communications with the one or more additional mobile devices, determining a second quantity of beamforming resources associated with the first beamforming technique and available at the wireless network base station;
determining, based at least in part on the virtual network and the second quantity of beamforming resources, a second threshold distance;
determining, based at least in part on a second signal received from the mobile device, a second distance between the mobile device and the wireless network base station;
determining that the second distance between the mobile device and the wireless network base station meets or exceeds the second threshold distance; and
communicating with the mobile device using the second beamforming technique.

15. A non-transitory computer-readable media storing computer-executable instructions that, when executed by one or more processors, cause the one or more processors configured at a wireless network base station to perform operations comprising:
communicating with a mobile device using a first beamforming technique;
determining, based at least in part on a signal received from the mobile device, a distance between the mobile device and the wireless network base station;
determining a virtual network associated with the mobile device;
determining a quantity of beamforming resources associated with the first beamforming technique and available at the wireless network base station;
determining, based at least in part on the virtual network and the quantity of sounding reference signal-based beamforming resources, a threshold distance;
determining that the distance between the mobile device and the wireless network base station meets or exceeds the threshold distance;
generating, based at least in part on determining that the distance between the mobile device and the wireless network base station meets or exceeds the threshold distance, a beamforming configuration associated with a second beamforming technique distinct from the first beamforming technique; and
transmitting the beamforming configuration to the mobile device.

16. The non-transitory computer-readable media of claim 15, wherein the signal received from the mobile device comprises a reference signal received power (RSRP) indicator.

17. The non-transitory computer-readable media of claim 15, wherein the signal received from the mobile device comprises a sounding reference signal (SRS).

18. The non-transitory computer-readable media of claim 15, wherein determining the threshold distance comprises:
determining that the quantity of beamforming resources falls below a resource quantity threshold; and
determining the threshold distance further based at least in part on determining that the quantity of beamforming resources falls below the resource quantity threshold.

19. The non-transitory computer-readable media of claim 15, wherein determining the threshold distance comprises:
determining that the virtual network is a low data throughout virtual network; and
determining the threshold distance further based at least in part on determining that the virtual network is the low data throughout virtual network.

20. The non-transitory computer-readable media of claim 19, wherein determining the threshold distance further comprises reducing the threshold distance based at least in part on determining that the virtual network is the low data throughout virtual network.
